(19) United States
(12) Patent Application Publication
(10) Pub. No.: US 2010/0256787 A1
(43) Pub. Date: Oct. 7, 2010

(54) BUILDING EQUIPMENT SYSTEM AND CONTROL METHOD THEREOF

(75) Inventors: Mun Hwan LEE, Seoul (KR); Byoung Keun Cha, Seoul (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/699,424

(22) Filed: Feb. 3, 2010

(30) Foreign Application Priority Data
Apr. 2, 2009 (KR) 10-2009-0008995
Apr. 2, 2009 (KR) 10-2009-0008996

(51) Int. Cl. G06F 17/00

(52) U.S. Cl. 700/90

(57) ABSTRACT

A building equipment system, which is capable of easily registering building equipment units using a central control unit by automatically assigning attribute information and control point addresses of the building equipment units when the building equipment units are connected, and a control method thereof are provided. The building equipment system includes a gateway unit which generates control point setting information when building equipment units are connected, and a central control unit which displays an object image corresponding to the building equipment units and a control screen for displaying operations of the building equipment units, based on the control point setting information.

The present application claims priority to Korean Application No. 10-2009-0008995 and No. 10-2009-0008996 filed in Korea on Feb. 4, 2009, the entire contents of which are hereby incorporated by reference for all purposes as if set forth herein.

### BACKGROUND OF THE INVENTION

1. Field of the Invention

The present invention relates to a building equipment system, which is capable of easily registering building equipment units using a central control unit by automatically assigning attribute information and control point addresses of the building equipment units when the building equipment units are connected, and a control method thereof.

2. Discussion of the Related Art

Generally, because a building includes many offices and rooms, a building equipment system includes a plurality of building equipment units including illumination apparatuses, heating apparatuses and air conditioners.

The building equipment system controls the plurality of building equipment units using a central control unit so as to efficiently perform management and control.

For example, if the plurality of building equipment units includes a multi-type air conditioner, the building equipment system checks the operation states of the plurality of multi-type air conditioners, and controls the plurality of multi-type air conditioners using the central control unit according to the checked result.

When control points of indoor and outdoor units of the plurality of multi-type air conditioners are registered and set, an engineer individually sets and registers control point setting information of the indoor and outdoor units connected to the central control unit.

Accordingly, the central control unit receives the control point setting information from the engineer and sets and registers the indoor and outdoor units.

In the building equipment system, because the engineer individually inputs the control point setting information of the plurality of building equipment units and the building equipment units are set and registered using the central control unit, set up time is increased and efficiency is decreased.

Accordingly, as the number of the plurality of building equipment units connected to the building equipment system is increased, research into a method of easily setting and registering the plurality of building equipment units using the central control unit has been conducted.

### SUMMARY OF THE INVENTION

An advantage of the present invention is to provide a building equipment system, which is capable of easily registering building equipment units using a central control unit by automatically assigning attribute information and control point addresses of the building equipment units when the building equipment units are connected, and a control method thereof.

To achieve the above advantage, a building equipment system according to a first embodiment of the present invention includes: a gateway unit generating control point setting information when building equipment units are connected; and a central control unit displaying an object image corresponding to each of the building equipment units and a control screen for displaying the operation of each of the building equipment units, based on the control point setting information.

To achieve the above advantage, a building equipment system according to another embodiment of the present invention includes: a gateway unit generating control point setting information when building equipment units are connected; and a central control unit displaying an object image corresponding to each of the building equipment units and a control screen for displaying an operation of each of the building equipment units, based on the control point setting information, wherein the gateway unit includes a connection unit to which the building equipment units are connected; an equipment recognition unit recognizing equipment types of the building equipment units connected to the connection unit and generating control point information using an equipment library coincident with the equipment types; and a control unit mapping the control point information to control point basic information of the equipment types of the building equipment units set by the central control unit and generating the control point setting information.

To, further achieve the above advantages, a method of controlling a building equipment system according to an exemplary embodiment of the present invention includes: determining whether or not building equipment units are connected; generating control point setting information when the building equipment units are connected; and transmitting the control point setting information to a central control unit.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a systematic diagram of a building equipment system according to the present invention;

FIG. 2 is a functional block diagram showing the configuration of a building equipment system according to a first embodiment of the present invention;

FIG. 3 is a flowchart illustrating a method of controlling a building equipment system according to the first embodiment of the present invention;

FIG. 4 is a functional block diagram showing the configuration of a building equipment system according to a second embodiment of the present invention; and

FIG. 5 is a flowchart illustrating a method of controlling a building equipment system according to the second embodiment of the present invention.

### DETAILED DESCRIPTION OF THE PREFERRED EMBODIMENTS

A building equipment system and a control method thereof according to the present invention will be described in detail with reference to the accompanying drawings.

There may be a plurality of embodiments of the building equipment system according to the present invention, but, hereinafter, a most preferred embodiment will be described.

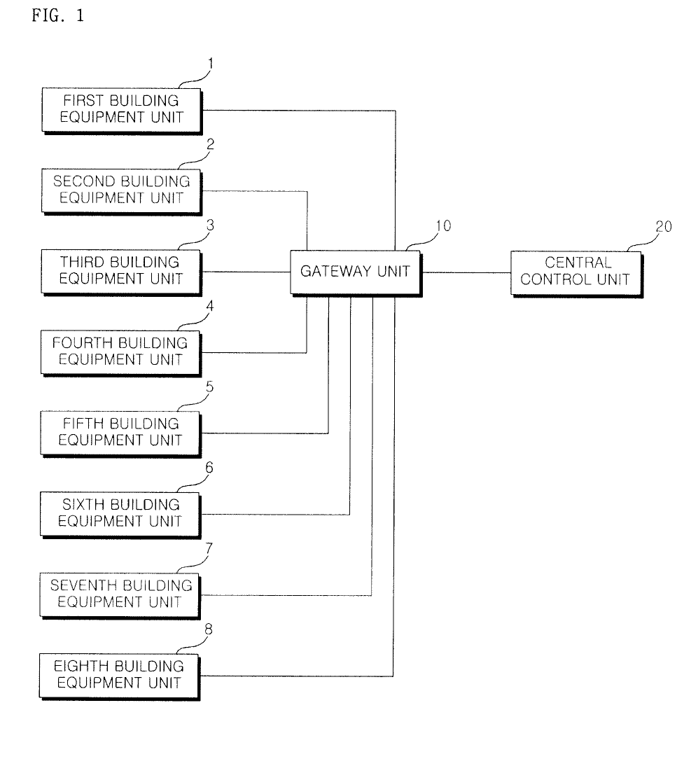

FIG. 1 is a systematic diagram of a building equipment system according to the present invention.

Referring to FIG. 1, the building equipment system includes first to eighth building equipment units 1 to 8, a gateway unit 10 and a central control unit 20.

The first to eighth building equipment units 1 to 8 are of different types, and are equipment units that may be electronically controlled in the present embodiment, such as an indoor unit, an outdoor unit, a cooling tower, a motor, and a compressor included in at least one of a water cooling type air conditioner and an air cooling type air conditioner, and are mounted for conditioning an indoor space of a large-sized building and a high-rise building.

Although the equipment units included in the water cooling type air conditioner and the air cooling type air conditioner mounted in the building are described as the first to eighth building equipment units 1 to 8 in the present embodiment, the present invention is not limited thereto and illumination apparatuses and a plurality of sensors may be included.

The gateway unit 10 is connected to the first to eighth building units 1 to 8 by wiring, and a Direct Digital Controller (DDC) and a Programmable Logic Controller (PC) may be used.

The PLC controls the first to eighth building equipment units 1 to 8 by connecting to a control contact point, and the DDC controls the first to eighth building equipment units 1 to 8 connected not based on an Open protocol as in the PLC, but based on RS485 communication or Ethernet.

That is, the gateway unit 10 recognizes the equipment types and generates control point setting information using an equipment library describing the various equipment types, when the first to eighth building equipment units 1 to 8 are each separately connected.

The central control unit 20 receives the control point setting information generated by the gateway unit 10 through RS485 communication or Ethernet, and displays an object image and a control screen for displaying the operation of each of the first to eighth building equipment units 1 to 8 based on the control point setting information.

The central control unit 20 may be a computer or other central processing unit and centrally controls the first to eighth building equipment units 1 to 8 connected to the gateway unit 20.

Although the first to eighth building equipment units 1 to 8, the gateway unit 10 and the central control unit 20 are connected through RS485 communication or Ethernet communication in the present building equipment system, other protocols may be used.

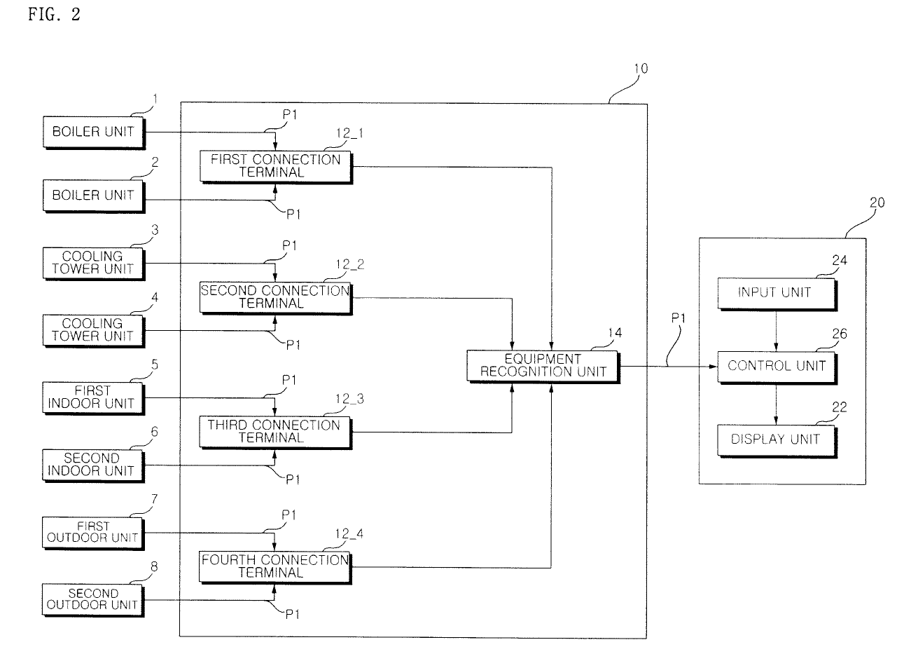

FIG. 2 is a functional block diagram showing the configuration of a building equipment system according to a first embodiment of the present invention.

Referring to FIG. 2, the present building equipment system includes first to eighth building equipment units 1 to 8, a gateway unit 10 and a central control unit 20.

In the present embodiment, the first to eighth building equipment units 1 to 8 include boiler units 1 and 2, cooling tower units 3 and 4, first and second indoor units 5 and 6 and first and second outdoor units 7 and 8. The present invention is not limited thereto and other building equipment units may be included.

The boiler units 1 and 2 and the cooling tower units 3 and 4 include other building equipment units included in a boiler and a cooling tower, respectively.

The gateway unit 10 includes a connection unit 12 to which the first to eighth building equipment units 1 to 8 are connected, and an equipment recognition unit 14 for recognizing the equipment types of the first to eighth building equipment units 1 to 8 connected to the connection unit 12 and generating control point setting information using an equipment library describing the various equipment types.

The connection unit 12 includes first, second third and fourth connection terminals 12_1, 12_2, 12_3 and 12_4 such that the boiler units 1 and 2, the cooling tower units 3 and 4, the first and second indoor units 5 and 6 and the first and second outdoor units 7 and 8 of the first to eighth building equipment units 1 to 8 are separately connected.

Each of the first, second, third and fourth connection terminals 12_1, 12_2, 12_3 and 12_4 is connected to the equipment recognition unit 14 by an RS485 communication line P1.

The equipment recognition unit 14 recognizes the equipment types of the boiler units 1 and 2, the cooling tower units 3 and 4, the first and second indoor units 5 and 6 and the first and second outdoor units 7 and 8 separately connected to the first, second, third and fourth connection terminals 12_1, 12_2, 12_3 and 12_4 through RS485 communication lines.

The equipment recognition unit 14 generates the control point setting information using the equipment library describing the various equipment types.

The equipment library includes attribute information and control point addresses for the various equipment types and is used to assign a regular point control address according to the equipment type.

The control point addresses may be combination of gateway unit number, equipment type, connection terminal number, and connection point of a connection terminal. The attribute information may be such as equipment type, model number and control attributes (power on/off, temperature, fan speed, etc.) and attribute range (maximum temperature and minimum temperature, etc.).

The equipment recognition unit 14 generates the control point setting information including the attribute information and the control point addresses of the boiler units 1 and 2, the cooling tower units 3 and 4, the first and second indoor units 5 and 6 and the first and second outdoor units 7 and 8.

That is, the equipment recognition unit 14 applies code numbers or identifiers according to the equipment types and generates the control point setting information in which the attribution information and the control point addresses set in the equipment library are automatically assigned according to the code numbers or the identifiers.

The central control unit 20 displays an object image and a control screen for displaying the operation of each of the boiler units 1 and 2, the cooling tower units 3 and 4, the first and second indoor units 5 and 6 and the first and second outdoor units 7 and 8 according to the control point setting information received from the gateway unit 10.

The central control unit 20 includes a display unit 22 for displaying the object image and the control screen, an input unit 24 for inputting a selection command and an operation command related to the object image, and a control unit 26 for controlling the object image and the control screen to be displayed on the display unit 22 and controlling the boiler units 1 and 2, the cooling tower units 3 and 4, the first and second indoor units 5 and 6 and the first and second outdoor units 7 and 8 according to the selection command and the operation command received from the input unit 24.

That is, the control unit 26 controls the object image including the control point setting information to be displayed on the display unit 22, displays the attribute information and the control point addresses on the display unit 22 when the selection command is input by the input unit 24, and displays the control screen on the display unit 22 when the operation command is input.

Because the building equipment system according to the first embodiment automatically generates the control point setting information using the equipment library in which the attribute information and the control point addresses are stored according to the equipment types of the building equipment units, it is possible to reduce a registration time using the control point setting information which otherwise would be manually input by an engineer. This reduces the installation time and minimizes errors in registering the building equipment when the object image is displayed by the central control unit.

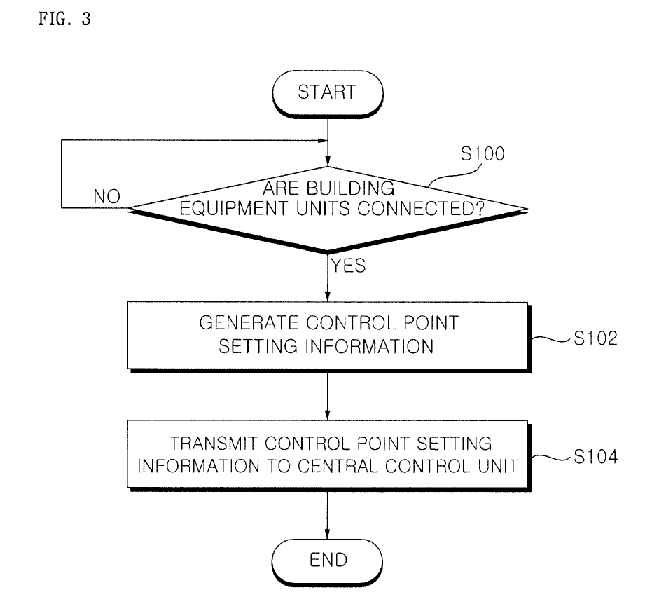

FIG. 3 is a flowchart illustrating a method of controlling a building equipment system according to the first embodiment of the present invention.

Referring to FIG. 3, the present building equipment system determines whether or not any building equipment units are connected (S100).

That is, the gateway unit 10 determines whether or not any of the first to eighth building equipment units 1 to 8 are connected to the connection unit 12 through the RS communication or Ethernet communication line.

In other words, the gateway unit 10 performs RS communication using the RS communication line P1 in order to determine whether or not any of the first to eighth building equipment units 1 to 8 are connected to the first to fourth connection terminals 12_1 to 12_4 of the connection unit 12, and determines that the building equipment units are connected, if communication is possible.

When the building equipment units are connected, the control point setting information is generated (S102).

That is, the gateway unit 10 generates the control point setting information including the attribute information and the control point addresses using the equipment library according to the equipment types of the first to eighth building equipment units 1 to 8, when the first to eighth building equipment units 1 to 8 are connected to the first to fourth connection terminals 12_1 to 12_4.

In other words, the equipment recognition unit 14 recognizes the first to eighth building equipment units 1 to 8 are connected and automatically assigns the attribute information and the control point addresses using the equipment library according to the equipment types of the first to eighth building equipment units 1 to 8 connected through RS communication lines.

At this time, the equipment recognition unit 14 generates the control point setting information including the attribute information and the control point addresses.

The attribution information and the control point addresses may be displayed by code numbers or identifiers according to the equipment types.

The control point setting information is transmitted to the central control unit (S104).

That is, the gateway unit 10 transmits the control point setting information of the connected first to eighth building equipment units 1 to 8 to the central control unit 20.

At this time, the central control unit 20 displays the object image, and the attribute information and the control point addresses included in the object image according to the control point setting information.

The central control unit 20 can individually or centrally control the first to eighth building equipment units 1 to 8 using the same object image as the first to eighth building equipment units 1 to 8.

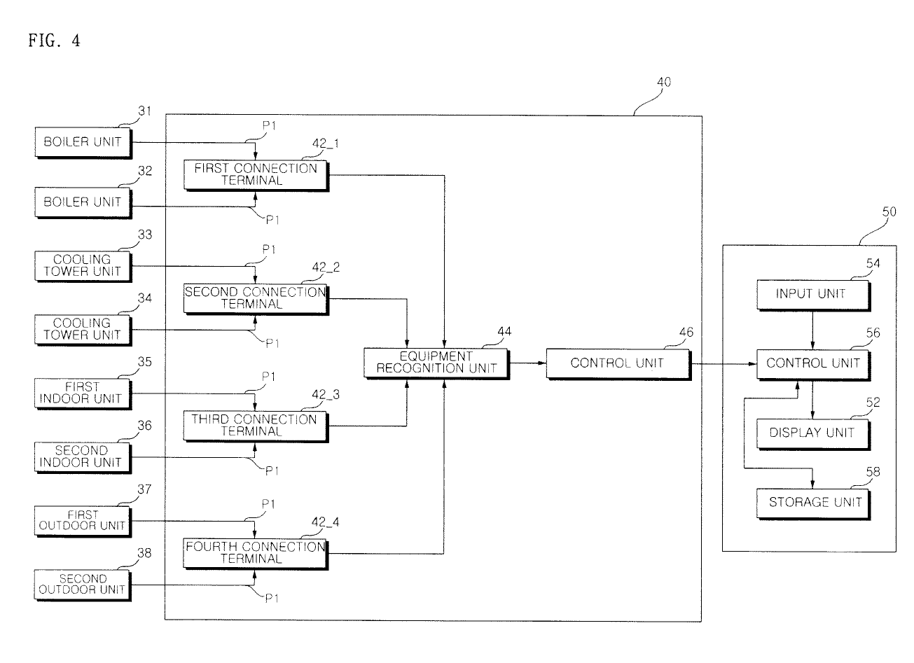

FIG. 4 is a functional block diagram showing the configuration of a building equipment system according to a second embodiment of the present invention.

Referring to FIG. 4, the present building equipment system includes first to eighth building equipment units 31 to 38, a gateway unit 40 and a central control unit 50.

The first to eighth building equipment units 31 to 38 include boiler units 31 and 32, cooling tower units 33 and 34, first and second indoor units 35 and 36 and first and second outdoor units 37 and 38.

The boiler units 31 and 32, the cooling tower units 33 and 34, the first and second indoor units 35 and 36 and the first and second outdoor units 37 and 38 are separately connected to the gateway unit 40 according to the equipment types.

The gateway unit 40 includes a connection unit 42 to which the first to eighth building equipment units 31 to 38 are connected, an equipment recognition unit 44 for recognizing the equipment types of the first to eighth building equipment units 31 to 38 connected to the connection unit 42 and for generating the control point information using an equipment library describing the various equipment types, and a control unit 46 for mapping the control point information to control point basic information of the equipment types of the first to eighth building equipment units 31 to 38 set by the central control unit 50 and generating control point setting information.

The connection unit 42 includes first, second third and fourth connection terminals 42_1, 42_2, 42_3 and 42_4 such that the boiler units 31 and 32, the cooling tower units 33 and 34, the first and second indoor units 35 and 36 and the first and second outdoor units 37 and 38 of the first to eighth building equipment units 31 to 38 are separately connected.

Each of the first, second, third and fourth connection terminals 42_1, 42_2, 42_3 and 42_4 is connected to the equipment recognition unit 44 by an RS485 communication line P1 for RS485 communication.

The equipment recognition unit 44 recognizes the equipment types of the boiler units 31 and 32, the cooling tower units 33 and 34, the first and second indoor units 35 and 36 and the first and second outdoor units 37 and 38 each separately connected to the first, second, third and fourth connection terminals 42_1, 42_2, 42_3 and 42_4 through RS485 communication.

The equipment recognition unit 44 generates the control point information using the equipment library describing the various equipment types.

The equipment library includes attribute information and control point addresses set according to the equipment types and is used to assign regular point control addresses according to the equipment types.

The equipment recognition unit 44 generates the control point information including the attribute information and the control point addresses of the boiler units 31 and 32, the cooling tower units 33 and 34, the first and second indoor units 35 and 36 and the first and second outdoor units 37 and 38.

That is, the equipment recognition unit 44 applies code numbers or identifiers according to the equipment types and generates the control point information in which the attribution information and the control point addresses set in the equipment library are automatically assigned according to the code numbers or the identifiers.

The control unit 46 maps the control point information generated by the equipment recognition unit 44 to the control point basic information transmitted from the central control unit 50, and automatically generates the control point setting information.

The control point basic information is setting information (model number, control attributes by equipment type and default value of attribute, etc.) related to the operation of the equipment types of the boiler units 31 and 32, the cooling tower units 33 and 34, the first and second indoor units 35 and 36 and the first and second outdoor units 37 and 38, and the control point information includes the attribute information and the control point addresses of the boiler units 31 and 32, the cooling tower units 33 and 34, the first and second indoor units 35 and 36 and the first and second outdoor units 37 and 38.

That is, the control unit 46 maps the control point information to the control point basic information and generates the control point setting information including the setting information, the attribute information and the control point addresses of the boiler units 31 and 32, the cooling tower units 33 and 34, the first and second indoor units 35 and 36 and the first and second outdoor units 37 and 38.

For example, if model number of the control point information is same as model number of the control point basic information, then the control unit 46 maps the setting information, the attribute information and the control point addresses to one object. If control attributes of the control point information is similar to control attributes of control point basic information, then the control unit 46 may map the setting information, the attribute information and the control point addresses to one object.

The setting information includes an object image to be displayed by the central control unit 50.

The central control unit 50 displays the object image and a control screen for displaying the operation of each of the boiler units 31 and 32, the cooling tower units 33 and 34, the first and second indoor units 35 and 36 and the first and second outdoor units 37 and 38 according to the control point setting information received from the gateway unit 40.

The central control unit 50 includes a display unit 52 for displaying the object image and the control screen, an input unit 54 for inputting a selection command and an operation command relating to the object image, and a control unit 56 for controlling the object image and the control screen to be displayed on the display unit 52 and controlling the boiler units 31 and 32, the cooling tower units 33 and 34, the first and second indoor units 35 and 36 and the first and second outdoor units 37 and 38 according to the selection command and the operation command received from the input unit 54.

The central control unit 50 further includes a storage unit 58 for storing the control point information. The control point information is the setting information relating to the operation of each of the boiler units 31 and 32, the cooling tower units 33 and 34, the first and second indoor units 35 and 36 and the first and second outdoor units 37 and 38, and the setting information includes the equipment types and characteristic information according to use.

The control unit 56 controls the object image and the control screen to be displayed on the display unit 52 according to the control point setting information transmitted from the gateway unit 40, displays the attribute information and the control point addresses on the display unit 52 when the selection command is input using the input unit 54, and displays the control screen on the display unit 52 when the operation command is input.

The control unit 56 updates the control point basic information using the control point setting information and stores the updated information in the storage unit 58.

Although one gateway unit 40 is used in FIG. 4, at least two gateway units may be included. If at least two gateway units are included, the first to eighth building equipment units 31 to 38 may be divided according to the equipment types.

If at least two gateway units 40 are mounted, a plurality of DDCs and PLCs may be commonly mounted.

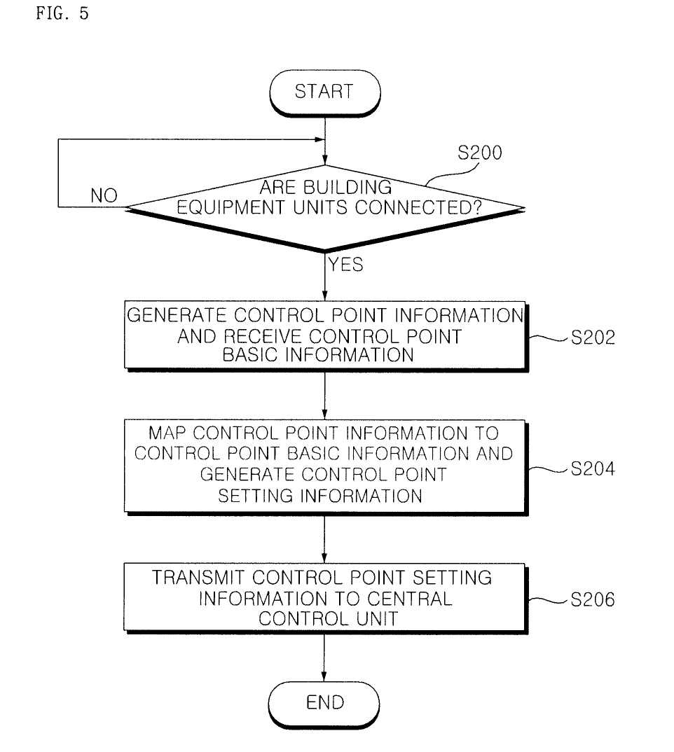

FIG. 5 is a flowchart illustrating a method of controlling a building equipment system according to the second embodiment of the present invention.

Referring to FIG. 5, the present building equipment system determines whether or not any of the building equipment units are connected (S200).

That is, the gateway unit 40 determines whether or not any of the first to eighth building equipment units 31 to 38 are connected to the connection unit 42 through RS communication or Ethernet communication line.

In other words, the gateway unit 40 performs RS communication using the RS communication line P1 in order to determine whether or not any of the first to eighth building equipment units 31 to 38 are connected to the first to fourth connection terminals 42_1 to 42_4 of the connection unit 42, and determines that the building equipment units are connected, if communication is possible.

When the building equipment units are connected, the control point information is generated according to the equipment types of the building equipment units and the control point basic information is received from the central control unit (S202).

That is, the gateway unit 40 generates the control point information according to the equipment types of the first to eighth building equipment units 31 to 38 and receives the control point basic information according to the equipment types from the central control unit 50, when the first to eighth building equipment units 31 to 38 are connected to the first to fourth connection terminals 42_1 to 42_4.

The equipment recognition unit 44 recognizes the equipment types of the connected first to eighth building equipment units 31 to 38, and generates the control point information including the attribute information and the control point addresses using the equipment library according to the equipment types.

The control unit 46 receives the control point basic information according to the equipment types from the central control unit 50.

The control point information is mapped to the control point basic information so as to generate the control point setting information (S204).

That is, the gateway unit 40 maps the control point information of the first to eighth building equipment units 31 to 38 to the received control point basic information according to the equipment types, and then generates the control point setting information.

In other words, the control unit 46 maps the control point information, in which the attribute information and the control point addresses are automatically assigned using the equipment library according to the equipment types of the first to eighth building equipment units 31 to 38 by the equipment recognition unit 44, to the control point basic information which is the setting information of the equipment types of the first to eighth building equipment units 31 to 38 according to the same equipment types, and generates the control point setting information.

The control point setting information includes the setting information, the attribute information and the control point addresses.

The control point setting information is transmitted to the central control unit (S206).

That is, the gateway unit 40 transmits the control point setting information of the connected first to eighth building equipment units 31 to 38 to the central control unit 50.

At this time, the central control unit 50 displays the object image, and the attribute information, the control point addresses and the setting information included in the object image according to the control point setting information.

The central control unit 50 can individually or centrally control the first to eighth building equipment units 31 to 38 using the same object image as the first to eighth building equipment units 31 to 38.

It will be understood by those skilled in the art that example embodiments can be implemented in other specific forms without changing the technical spirit or essential features of the present invention. Therefore, it should be noted that the forgoing embodiments are merely illustrative in all aspects and are not to be construed as limiting the invention. The scope of the invention is defined by the appended claims rather than the detailed description of the invention. All changes or modifications or their equivalents made within the meanings and scope of the claims should be construed as falling within the scope of the invention.

What is claimed is:

1. A building equipment system comprising:
a gateway unit that generates control point setting information when building equipment units are connected; and
a central control unit that displays an object image corresponding to each of the building equipment units and a control screen that displays an operation of each of the building equipment units based on the control point setting information.

2. The building equipment system of claim 1, wherein the gateway unit includes:
a connection unit to which the building equipment units are connected; and
an equipment recognition unit that recognizes equipment types of the building equipment units connected to the connection unit and that generates the control point setting information using an equipment library describing the various equipment types.

3. The building equipment system of claim 2, wherein the connection unit includes a plurality of connection terminals separately connected according to the equipment types of the building equipment units.

4. The building equipment system of claim 2, wherein the equipment recognition unit recognizes whether or not the building equipment units are connected through a communication link with the building equipment units.

5. The building equipment system of claim 2, wherein:
attribute information and control point addresses based upon the equipment types of the building equipment units are set in the equipment library, and
the control point setting information includes the attribute information and the control point addresses of the building equipment units.

6. The building equipment system of claim 1, wherein the central control unit includes:
a display unit that displays the object image and the control screen;
an input unit that inputs a selection command and an operation command of the object image; and
a control unit that controls the object image and the control screen to be displayed on the display unit and that controls the building equipment units according to the selection command and the operation command from the input unit.

7. The building equipment system of claim 6, wherein the control unit receives the control point setting information through on of an Ethernet communication link or RS communication link with the gateway unit.

8. The building equipment system of claim 6, wherein:
the control point setting information includes attribution information and control point addresses of the building equipment units, and
the control unit controls the attribute information and the control point addresses to be displayed on the display unit, when the selection command of the object image is input.

9. A building equipment system comprising:
a gateway unit generating control point setting information when building equipment units are connected; and
a central control unit that displays an object image corresponding to each of the building equipment units and a control screen for displaying an operation of each of the building equipment units, based on the control point setting information,
wherein the gateway unit includes:
a connection unit to which the building equipment units are connected;
an equipment recognition unit that recognizes equipment types of the building equipment units connected to the connection unit and that generate control point information using an equipment library coincident with the equipment types; and
a control unit that maps the control point information to control point basic information of the equipment types of the building equipment units set by the central control unit and that generates the control point setting information.

10. The building equipment system of claim 9, wherein the connection unit includes a plurality of connection terminals separately connected according to the equipment types of the building equipment units.

11. The building equipment system of claim 9, wherein the equipment recognition unit recognizes whether or not the building equipment units are connected through a communication link with the building equipment units.

12. The building equipment system of claim 9, wherein:
the control point basic information is setting information of the operation of each of the building equipment units,
the control point information includes attribute information and control point addresses of the building equipment units, and
the control unit generates the control point setting information in which the setting information, the attribute information and the control point addresses of the building equipment units are mapped and transmits the control point setting information to the central control unit.

13. The building equipment system of claim 9, wherein the central control unit updates the control point basic information using the control point setting information when the control point setting information is input.

14. A method of controlling a building equipment system, the method comprising:
determining whether or not building equipment units are connected;
generating control point setting information when the building equipment units are connected; and
transmitting the control point setting information to a central control unit.

15. The method of claim 14, wherein the determining includes determining whether or not the building equipment units are connected through RS communication with the building equipment units.

16. The method of claim 14, wherein the generating includes recognizing equipment types of the building equipment units and generating the control point setting information using an equipment library coincident with the equipment types, when the building equipment units are connected.

17. The method of claim 16, wherein:
attribute information and control point addresses according to the equipment types of the building equipment units are set in the equipment library, and
the control point setting information includes the attribute information and the control point addresses.

18. The method of claim 17, wherein the central control unit displays an object image including the attribute information and the control point addresses and a control screen for displaying an operation of each of the building equipment units, according to the control point setting information.

19. The method of claim 14, wherein the generating includes recognizing equipment types of the building equipment units, generating control point information using an equipment library coincident with the equipment types, mapping the control point information to control point basic information of the equipment types of the building equipment units set by the central control unit, and generating the control point setting information, when the building equipment units are connected.

20. The method of claim 19, wherein:
attribute information and control point addresses according to the equipment types of the building equipment units are set in the equipment library,
the control point information includes the attribute information and the control point addresses,
the control point basic information is setting information of the operation of each of the building equipment units, and
the control point setting information includes the setting information, the attribute information and the control point addresses.
